(19) United States
(12) Patent Application Publication
(10) Pub. No.: US 2007/0272337 A1
(43) Pub. Date: Nov. 29, 2007

(54) Pneumatic tire with tread siping

(76) Inventors: Lorie Jean Bovaird, Hudson, OH (US); Noel Lee Boarman, Akron, OH (US); Steven Amos Edwards, Akron, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/440,557

(22) Filed: May 25, 2006

(51) Int. Cl. B60C 11/12

(52) U.S. Cl. 152/209.18; 152/DIG. 3; 425/28.1

(57) ABSTRACT

A tire having a tread has at least one tread element with a multi-dimensional sipe formed in the tread element. The sipe has a width W, a depth Ds, and an effective length Le. The sipe has a first radially outermost portion with a constant effective length Le, a second transitional portion with a gradually increasing effective length Le, and a third radially innermost portion having a constant effective length Le greater than the effective length of the first portion.

### FIELD OF THE INVENTION

The present invention is related to a pneumatic tire. More specifically, the present invention is related to a tire having a tread wherein the tread is provided with a particular type of multi-dimensional siping wherein the length of the sipe is greater within the tread element than at the surface of the tire tread when the tire tread is substantially unworn.

### BACKGROUND OF THE INVENTION

The tread portion of a pneumatic tire generally comprises a plurality of circumferentially and laterally extending grooves defining ground engaging rubber elements, the elements being in the form of blocks or ribs or combinations thereof. The particular size and shape of the tread elements contribute significantly to the overall performance of the tire and are for that reason designed to achieve the desired tire characteristics.

Conventionally, tire treads are also provided with a feature known as a sipe. A sipe is a groove having a width in the range of about 0.1% to about 1% of the tread width, i.e. the arc length of the tread surface in the axial direction. The sipe tends to close when it is located in the tire footprint at zero speed and under normal load and pressure. Sipes are typically formed by steel blades inserted into a cast or machined mold or tread ring therefor.

A sipe may extend circumferentially or laterally about the tread in a straight, curved, or zigzag manner and may be as deep as the primary tread grooves or have a depth that is greater than the groove depth. The sipes can pass through the sides of the ribs and tread blocks or be confined to the interior of the tread elements. It is also known to have sipes lying in planes which are not perpendicular to tangents to the surface of the tread at their point of intersection; the inclination of the planes defining neighboring sipes can be identical or differ step wise along the tread element length. It is further known to use sipes having a depth that varies along its length.

The presence of sipes in a tread increases the number of biting edges in the tread. The local high pressure at each biting edge improves the wiping and digging action of the tread surface, conferring to a tire excellent traction on snow and ice. Furthermore, sipes improve the flexibility of the tread elements without destroying their solidity. The easy relative longitudinal sliding between the opposed faces of the sipe weakens the resistance of the tread elements to flexing in the contact area between tread and road and therefor slows down the heat buildup of the tire; however, the sliding of the opposed faces of the sipes creates friction between the opposing sipe faces and can lead to wear of the sipes.

### SUMMARY OF THE INVENTION

The present invention is directed to a tire comprising a multi-dimensional sipe and a blade used to manufacture such a sipe. The sipe is provided for increased biting edges and flexibility in the tire tread as the tire wears.

Disclosed herein is a tire having a tire tread, the tire tread comprising a plurality of grooves. The grooves form at least one tread element, the tread element having therein at least one sipe. The sipe has a width W, a sipe depth Ds, and an effective sipe length Le. The effective sipe length Le is the cross sectional area of the sipe at any plane perpendicular to the sipe depth Ds divided by the sipe width W. The sipe has a first radially outermost portion, a second transitional portion, and a third radially innermost third portion. The first sipe portion has a constant effective sipe length Le. The second sipe portion has a gradually increasing effective sipe length Le for the entire depth of the second sipe portion. The third sipe portion has a constant effective sipe length Le. Preferably, these three portions are radially adjacent to each other in the order recited above and are the only defined portions of differing configurations along the full depth of the sipe.

The first sipe portion has a configuration that is straight, curved, or mimics a configuration of a groove that forms the tread element in which the sipe is formed. The third sipe portion has a zig-zag, crenellated, scalloped, or undulating configuration.

In one aspect of the invention, the first sipe portion has a depth D1 of at least 5%, but not more than 20%, of the sipe depth Ds.

In another aspect of the invention, the second sipe portion has a depth D2 of at least 5%, but not more than 25%, of the sipe depth Ds.

In another aspect of the invention, the third sipe portion has a depth D3 of at least 60%, but not more than 85%, of the sipe depth Ds.

In another aspect of the invention, the third sipe portion has an effective sipe length Le of at least 110% greater than the effective sipe length Le of the first sipe portion.

Also disclosed is a sipe blade for forming a sipe in a tire tread. The blade has a thickness Wb and a pattern portion. The pattern portion has a configuration to form a sipe having a corresponding configuration. The pattern portion of the blade has a pattern depth Dp, and an effective pattern length Lpe. The effective pattern length Lpe is the cross sectional area of the pattern portion at any plane perpendicular to the pattern depth Dp divided by the blade thickness Wb. The pattern portion of the blade has a first uppermost pattern portion, a second transitional pattern portion, and a third lowermost pattern portion. The first pattern portion has a constant effective pattern length Lpe. The second pattern portion has a gradually increasing effective pattern length Lpe for the entire depth of the second pattern portion. The third pattern portion has a constant effective pattern length Lpe. Preferably, there is only a single transitional pattern portion in the pattern portion of the blade.

In one aspect of the invention, the first pattern portion has a depth D1 of at least 5% of the pattern depth Dp. The second pattern portion preferably has a depth D2 of at least 5% of the pattern depth Dp. The third pattern portion preferably has a depth D3 of at least 60% of the pattern depth Dp.

In another aspect of the invention, the first pattern portion has either a straight or curved configuration. The third pattern portion has a zig-zag, crenellated, scalloped, or undulating configuration.

### Definitions

The following definitions are controlling for the disclosed invention.

“Axial” and “axially” are used herein to refer to lines or directions that are parallel to the axis of rotation of a tire.

“Blade” means a protrusion in a tire curing mold that forms part of the tread design. The protrusion forms a corresponding depression in the finished tire tread.

“Radial” and “radially” are used to mean directions radially toward or away from the axis of rotation of the tire.

“Sipes” refer to small grooves molded into tread elements of a tire that subdivide the tread elements and improve traction characteristics. Sipes have a width in the range of about 0.1% to about 1% of the tread width and tend to close completely in a tire footprint. The depth of a sipe may vary around the circumference of the tread, or the depth of one sipe may be constant but vary from the depth of another sipe in the tire.

### BRIEF DESCRIPTION OF THE DRAWINGS

The invention will be described by way of example and with reference to the accompanying drawings in which:

FIG. 1 illustrates a tire tread;

FIG. 2 illustrates a cut sectional view of a sipe in the tread of FIG. 1;

FIG. 3 is a blade used to form the sipe similar to the sipe of FIG. 2;

FIGS. 4A and 4B are top and bottom views of the blade of FIG. 3; and

FIG. 5 is another tread illustration.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

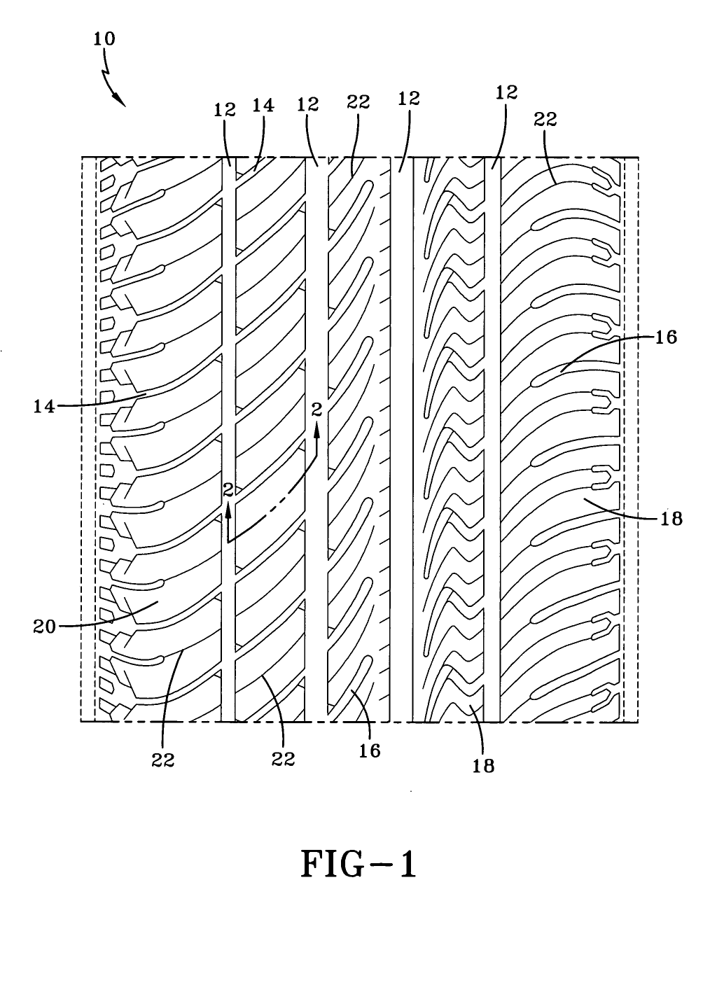

FIG. 1 is an exemplary tread 10 for a pneumatic tire. The tire employing the illustrated tread may be of a radial or bias construction; the more typical being a radial construction. The tire tread 10 has a plurality of circumferential grooves 12 and a plurality of lateral grooves 14, 16. These grooves 12, 14, 16, in different combinations from a plurality of tread elements 18, 20. Some of the lateral grooves 14 extend between the circumferential grooves 12 and some terminate within the tread element 20, creating a blind groove 16. For the illustrated tread, within each tread element 18, 20, the tread element being either a block, such as tread elements 20, or a rib, such as tread elements 18, is at least one sipe. The illustrated sipes 22 have an initial external configuration that at least partially mimics the configuration of the lateral grooves that form the instant tread element; as used herein mimicking is defined as either being identical or closely imitating such the sipe has the same general configuration as the groove configuration it is mimicking. Those skilled in the art will appreciate that the tread configuration may differ from that illustrated, and may have any tread element configuration desired by the tire engineer; the specific tread element configuration and the selection of sipes in the various tread elements is selected to meet the intended tire performance characteristics.

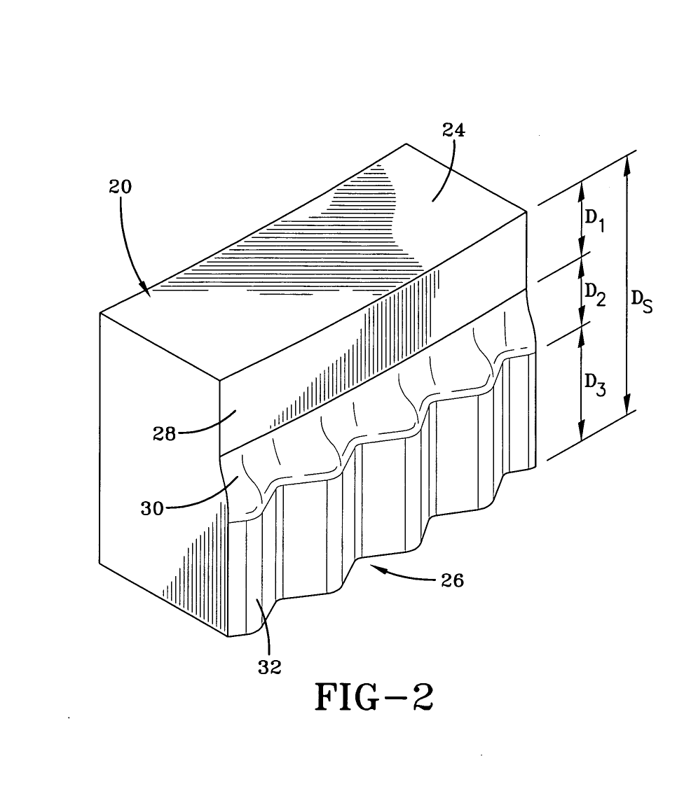

Every sipe 22 has a depth Ds as measured from the initial tread surface 24 to the radially innermost point of the sipe, see FIG. 2. This sipe depth Ds may also be defined as relative to either the block height or the adjacent groove depth; both the block height and the groove depth are measured when the tire is new and the tread substantially unworn. The sipe depth Ds may be less than, equal to, or greater than the adjacent groove depth, and may even vary along the length of the sipe. Each sipe 22 has an effective length Le. The effective length Le is calculated as the cross sectional area of the sipe 22, as measured in a plane perpendicular to the sipe depth Ds, divided by the width of the sipe; i.e. Le=area/width. The width of the sipe is measured when the sipe is not in the tire footprint.

In accordance with the present invention, at least one of the sipes in the tire tread has a configuration wherein the effective length of the sipe is increased from the effective length at the initial tread surface to the effective length of the sipe at points along the depth of the sipe. A cut-away of a tread element along the depth of the sipe is illustrated in FIG. 2. As measured from the new, or substantially unworn, tread surface, the inventive sipe 26 has a constant configuration for a depth D1 of at least 5% but not greater than 20% of the radially outermost portion of the sipe depth Ds, creating a first sipe portion 28. Due to the constant configuration of the first sipe portion 28, the effective sipe length Le for the first portion 28 is constant for the full depth D1 of the first sipe portion 28. The exact configuration for the first sipe portion 28 is preferably straight or has a slight curvature thereto. The constant configuration is preferably, but not necessarily, a configuration that mimics the configuration of an adjacent parallel groove.

Radially inward of the first sipe portion 28 is a second sipe portion 30 best referred to as the transition zone. The second sipe portion 30 has a depth D2 of at least 5% but not greater than 25% of the sipe depth Ds. In the second sipe portion 30, the sipe configuration transforms from one constant configuration, that of the first sipe portion 28, to a second constant configuration, that of the third sipe portion 32, wherein along the entire depth D2 of the second sipe portion 30, the effective length Le of the sipe 26 is gradually increasing, and the effective length Le does not decrease.

Radially inward of the second sipe portion 30 is the third, and radially innermost sipe portion 32. The third sipe portion 32 has a depth D3 of at least 60% of the sipe depth Ds, preferably, at least 75% of the sipe depth Ds, but not more than 85% of the sipe depth Ds. In the third sipe portion 32, the sipe configuration is constant, with the effective length Le of the sipe portion 32 being constant, and the effective length Le being greater than the effective sipe length Le of the first sipe portion 28. The effective length Le of the third sipe portion 32 is at least 110% greater than the effective length Le of the first sipe portion 28, and more preferably 120% greater than the effective length Le of the first sipe portion 28. The third sipe portion 32 has a zig-zag, crenellated, scalloped, or undulating configuration; FIG. 2 illustrates a zig-zag configuration for the third sipe portion 32.

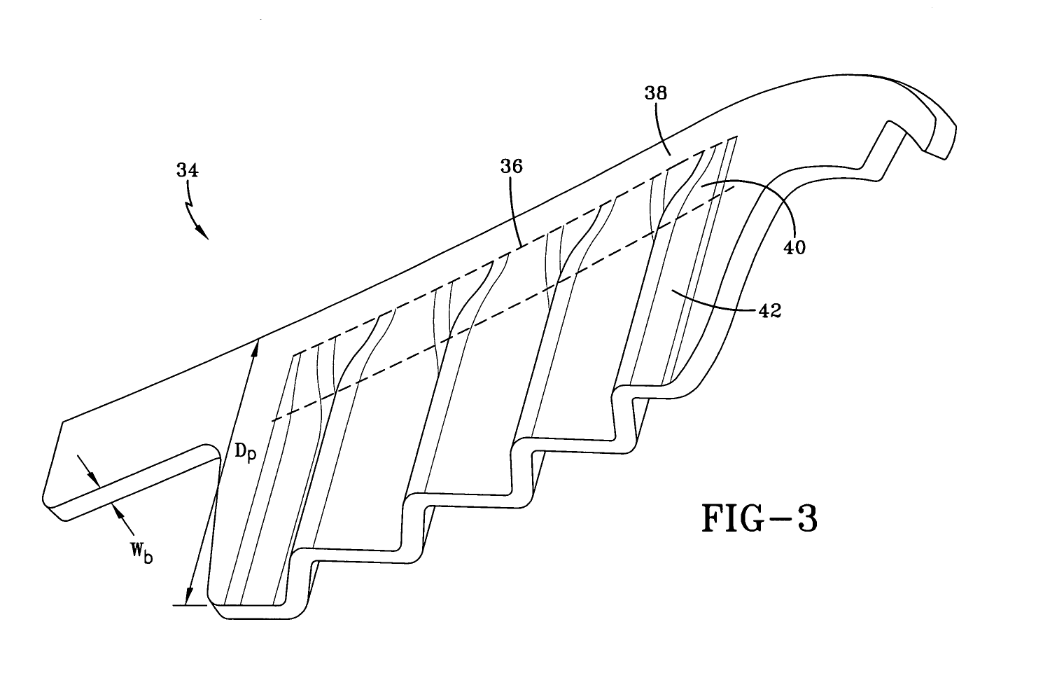

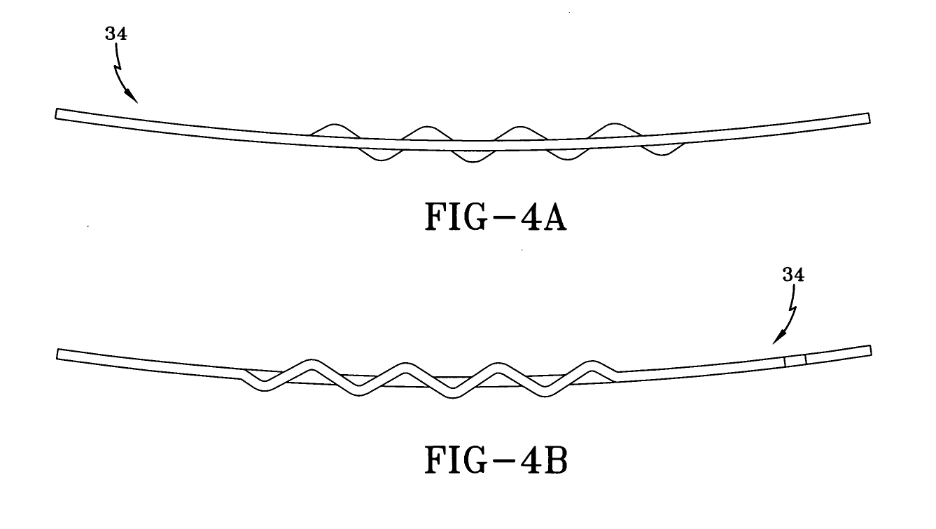

FIGS. 3, 4A and 4B illustrate a blade 34 useful for manufacturing a sipe 26 of the type shown in FIG. 2. The blade 34 has a defined thickness Wb, and has a pattern portion 36 that creates the multi-dimensional sipe 26 in a tire tread. Those skilled in the art will appreciate that the full blade that would be employed/mounted in a specific tire mold for production is not being illustrated herein; instead, only a portion of the production blade is being illustrated. If this were a finished blade for mounting in a tire mold, additional blade material would be illustrated above the pattern portion for mounting the blade into a mold. The pattern portion 36 of the sipe blade 34 has a pattern depth Dp. The pattern portion 36 has an effective pattern length Lpe. The effective pattern length Lpe is calculated as the cross sectional area of the pattern portion 36 at any plane perpendicular to the pattern depth Dp divided by the blade thickness Wb, i.e. Lpe=cross sectional area/blade thickness Wb.

The pattern portion 36 of the blade 34 itself has three defined portions 38, 40, 42. The first pattern portion 38 has a constant configuration and a constant effective pattern length Lpe for a depth D1 of at least 5% but not greater than 20% of the uppermost portion of the pattern depth Dp. The configuration for the first pattern portion 38 is preferably straight or has a slight curvature thereto. The constant configuration may also mimic the configuration of a groove that will be formed adjacent to the formed sipe.

Directly adjacent to the first pattern portion 38 is a second pattern portion 40 best referred to as the transition zone. The second pattern portion 40 has a depth D2 of at least 5% but not greater than 25% of the pattern depth Dp. In the second pattern portion 40, the configuration transforms from one constant configuration, that of the first pattern portion 38, to a second constant configuration, that of the third pattern portion 42, wherein along the entire depth of the second pattern portion 40, the effective length Lpe of the pattern is gradually increasing.

Inward and directly adjacent to the second pattern portion 40 is the third and innermost pattern portion 42. The third pattern portion 42 has a depth D3 of at least 60% of the pattern depth, preferably, at least 75% of the pattern depth, but not more than 85% of the pattern depth. In the third pattern portion 42, the pattern configuration is constant, with the effective length Lpe of the pattern portion 42 being constant, and the effective length Lpe being greater than the effective length Lpe of the first pattern portion 38. The effective length Lpe of the third pattern portion 42 is at least 110% greater than the effective length Lpe of the first pattern portion 38, and more preferably 120% greater than the effective length Lpe of the first pattern portion 38. The third pattern portion 42 has a zig-zag, crenellated, scalloped, or undulating configuration; FIG. 3 illustrates a zig-zag configuration for the third pattern portion 42.

FIG. 4A is a top view of the blade 34 of FIG. 3. As seen, the blade 34 has a slight curvature along the length of the blade. This curve extends along the length and depth of the blade 34 and creates a dominant pattern for the sipe blade and the sipe created therefrom. FIG. 4B is a bottom view of the same blade 34; again showing the dominant pattern of the curve that extends the depth of the blade 34. While this blade 34 is illustrated with a curve, as noted previously, the blade, and the sipe formed therefrom, may also have a straight configuration or one that mimics an adjacent groove being formed in the tire tread.

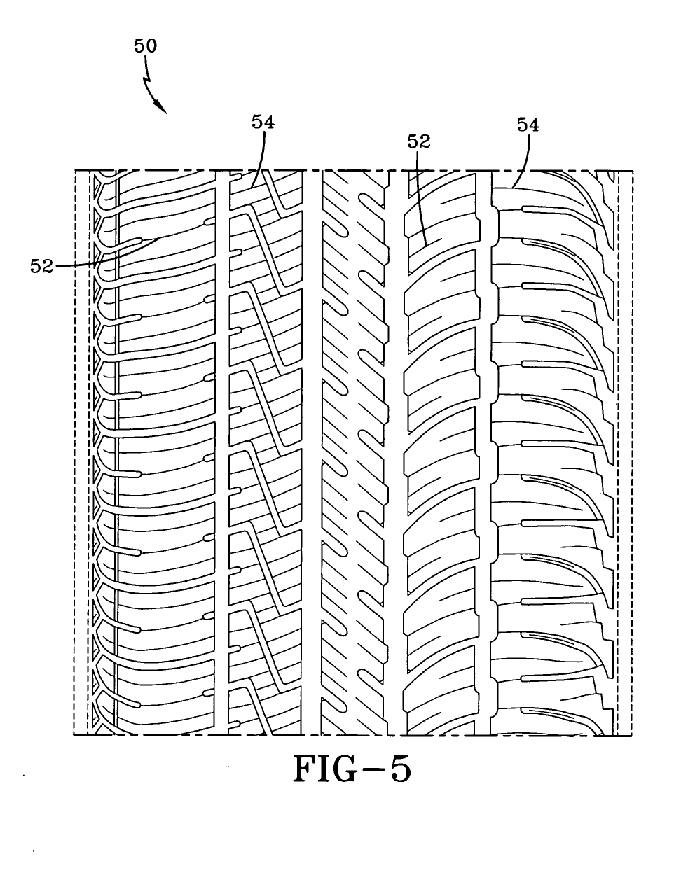

As seen in the tread of FIG. 1, at the tread surface, all of the sipes 22 have a surface configuration that mimics the adjacent lateral grooves 14, 16, though not all of the illustrated sipes 22 may have a varying configuration in accordance with the invention. The selection of which sipes 22 are provided with a varying pattern along its depth is determined by numerous factors, including but not limited to, desired characteristics of the tire, ease of manufacturing the blade to make the sipe, and ease of manufacturing the tire using such a blade. An alternative tread configuration is illustrated in FIG. 5. In this tread 50, the surface configuration of a majority of the sipes 52 mimics an adjacent groove configuration and the non-mimicking sipes 54 have a straight or slightly curved configuration. For both the treads 10, 50 illustrated, the tire designer might select to form only sipes in the axially outermost tread element rows or the element row located on the equatorial plane of the tire with the disclosed dimensional sipe configuration.

Sipes in accordance with the present invention provide for varying stiffness of the tread elements in which the sipes are formed during the tire tread life. Also, the increased effective length of the sipe as the sipe wears provides for more biting edges in the tire tread.

What is claimed is:

1. A tire having a tire tread, the tire tread comprising a plurality of grooves, the grooves forming at least one tread element, the tread element having therein at least one sipe, the sipe having a width W, a sipe depth Ds, and an effective sipe length Le, the effective sipe length Le being calculated as the cross sectional area of the sipe at any plane perpendicular to the sipe depth Ds divided by the sipe width W, the tire being characterized by the sipe having a first radially outermost portion, a second transitional portion, and a third radially innermost third portion, wherein,
the first sipe portion has a constant effective sipe length Le,
the second sipe portion has a gradually increasing effective sipe length Le for the entire depth of the second sipe portion, and
the third sipe portion has a constant effective sipe length Le.

2. The tire of claim 1 wherein the first sipe portion has a depth D1 of at least 5% of the sipe depth Ds.

3. The tire of claim 1 wherein the first sipe portion has a depth D1 of not more than 20% of the sipe depth Ds.

4. The tire of claim 1 wherein the second sipe portion has a depth D2 of at least 5% of the sipe depth Ds.

5. The tire of claim 1 wherein the second sipe portion has a depth D2 of not more than 25% of the sipe depth Ds.

6. The tire of claim 1 wherein the third sipe portion has a depth D3 of at least 60% of the sipe depth Ds.

7. The tire of claim 1 wherein the third sipe portion has a depth D3 of not more than 85% of the sipe depth.

8. The tire of claim 1 wherein the third sipe portion has an effective sipe length Le of at least 110% greater than the effective sipe length Le of the first sipe portion.

9. The tire of claim 1 wherein the first sipe portion has a configuration that is straight, curved, or mimics a configuration of a groove that forms the tread element in which the sipe is formed.

10. The tire of claim 1 wherein the sipe has only three radially adjacent sipe portions along the full depth of the sipe.

11. The tire of claim 1 wherein the sipe has only the one transition portion wherein the effective length Le of the sipe is gradually increasing.

12. The tire of claim 1 wherein the third sipe portion has a zig-zag, crenellated, scalloped, or undulating configuration.

13. A sipe blade for forming a sipe in a tire tread, the blade having a thickness Wb and comprising a pattern portion, the pattern portion having a configuration to form a sipe having a corresponding configuration, the pattern portion of the blade having a pattern depth Dp, and an effective pattern length Lpe, the effective pattern length being calculated as the cross sectional area of the pattern portion at any plane perpendicular to the pattern depth Dp divided by the blade thickness Wb, the blade being characterized by the pattern portion of the blade having a first uppermost pattern portion, a second transitional pattern portion, and a third lowermost pattern portion, wherein,
the first pattern portion has a constant effective pattern length Lpe,
the second pattern portion has a gradually increasing effective pattern length Lpe for the entire depth of the second pattern portion, and
the third pattern portion has a constant effective pattern length Lpe.

14. The sipe blade of claim 13 wherein the first pattern portion has a depth D1 of at least 5% of the pattern depth Dp.

15. The sipe blade of claim 13 wherein the second pattern portion has a depth D2 of at least 5% of the pattern depth Dp.

16. The sipe blade of claim 13 wherein the third pattern portion has a depth D3 of at least 60% of the pattern depth Dp.

17. The sipe blade of claim 13 wherein the first pattern portion has either a straight or curved configuration.

18. The sipe blade of claim 1 wherein the third pattern portion has a zig-zag, crenellated, scalloped, or undulating configuration.

19. The sipe blade of claim 1 wherein the pattern has only the one transition portion wherein the effective length Lpe of the pattern is gradually increasing.
